(19) United States
(12) Patent Application Publication
(10) Pub. No.: US 2011/0007434 A1
(43) Pub. Date: Jan. 13, 2011

(54) OVER CURRENT PROTECTING DEVICE AND METHOD ADAPTED TO DC-DC CONVERTER

(75) Inventors: Wei Han, Suzhou (CN); Ching-Ji Liang, Taipei (TW); Chai-Lin Yu, Suzhou (CN); Ju-Ya Luo, Suzhou (CN)

Correspondence Address: KIRTON AND MCCONKIE, 60 EAST SOUTH TEMPLE,, SUITE 1800, SALT LAKE CITY, UT, 84111, US

(73) Assignees: ASUS TECHNOLOGY (SUZHOU) CO. LTD, Suzhou (CN); ASUSTEK COMPUTER INC., Taipei (TW)

(21) Appl. No.: 12/830,863

(22) Filed: Jul. 6, 2010

(30) Foreign Application Priority Data
Jul. 13, 2009 (TW) 098123641

(51) Int. Cl. H02H 9/02

(52) U.S. Cl. 361/18

(57) ABSTRACT

The invention discloses an over current protecting device and the method thereof. The over current protecting device is adapted to a DC-DC converter. A voltage output end of the DC-DC converter may generate an output current and transmit the output current to a load on a motherboard via a power copper layer on the motherboard. The over current protecting method includes the following steps: detecting a voltage drop on the power copper layer; controlling the DC-DC converter to operate normally when the voltage drop is smaller than a threshold value; and controlling the DC-DC converter to stop operating when the voltage drop is larger than the threshold value.

### FIELD OF THE INVENTION

The invention relates to an over current protecting device adapted to a DC-DC converter and the method thereof and, more particularly, to an over current protecting device adapted to the DC-DC converter which detects the voltage drop of a power copper layer on a motherboard and the method thereof.

### BACKGROUND OF THE INVENTION

A computer system usually has a power supply for providing stable direct voltage such as 12 volts (V) or 5V for the computer system to make the computer normally operate. However, the operation voltage needed by electronic devices such as a central processing unit (CPU), a control chipset or a memory in the computer system is different from the direct voltage provided by the power supply. Therefore, a motherboard on the computer system should have a DC-DC converter to convert a higher direct voltage (such as 12V) to the operation voltage (such as 1.3V) of the electronic devices. The electronic devices may be considered as a load of the DC-DC converter.

FIG. 1 is a schematic diagram showing a conventional DC-DC converter. The DC-DC converter includes a pulse width modulation (PWM) unit 10 and a power stage circuit 30. The PWM unit 10 may output a first driving signal (S1) and a second driving signal (S2), and it also controls the pulse widths of the first driving signal (S1) and the second driving signal (S2).

The power stage circuit 30 includes an upper power FET (M1), a lower power FET (M2), an output inductor (L) and an output capacitor (C). A drain (D) of the upper power FET (M1) is connected to a voltage input end (Vin), a gate (G) of the upper power FET (M1) receives the first driving signal (S1), and a source (S) of the upper power FET (M1) is connected to a first end of the output inductor (L). A drain (D) of the lower power FET (M2) is connected to the first end of the output inductor (L), a gate (G) of the lower power FET (M2) receives the second driving signal (S2), and a source (S) of the lower power FET (M2) is connected to the ground (GND). In addition, a second end of the output inductor (L) is a voltage output end (Vout), and the output capacitor (C) is connected between the voltage output end (Vout) and the ground (GND). The upper power FET (M1) and the lower power FET (M2) are n-type metal-oxide-semiconductor field-effect transistors (n-MOSFET).

The voltage output end (Vout) may be connected to a power copper layer 40 of the motherboard, and the power copper layer 40 is connected to the load 50 of the motherboard.

When the DC-DC converter is in the steady state, the voltage output end (Vout) provides a feedback signal (FB) to the PWM unit 10 to make the PWM unit control the first driving signal (S1) and the second driving signal (S2) according to the change of the output voltage (Vout). At that moment, the output inductor (L) may generate an inductor current (I_{L}), and the capacitor current (Ic) is zero. At that moment, the effective value of the inductor current (I_{L}) equals to the output current (I_{O}).

FIG. 2 is a schematic diagram showing the output voltage (Vout) and the output current (I_{O}) of the conventional DC-DC converter. When the DC-DC converter is in the steady state, via the control of the first driving signal (S1) and the second driving signal (S2), the output current (I_{O}) increases when the upper power FET (M1) is turned on and the lower power FET (M2) is turned off. On the contrary, when the upper power FET (M1) is turned on and the lower power FET (M2) is turned off, the output current (I_{O}) decreases. Therefore, the output current (I_{O}) may be kept at a value approximate to a steady state current (I1) (such as 10 A), and the output voltage (Vout) keeps at a fixed voltage (V1) (such as 1.3V)

In addition, when the load 50 of the DC-DC converter is short circuited, the DC-DC converter may generate an over larger output current (I_{O}). To prevent the inductor current (I_{L}) from increasing therewith and to prevent the upper power FET (M1), the lower power FET (M2), the output inductor (L) or the output capacitor (C) in the DC-DC converter from being damaged, an over current protecting device usually is additionally provided. Conventionally, the over current protecting device determines whether an over current is generated in the DC-DC converter by detecting the change of the inductor current (I_{L}).

For example, the over current protecting device determines whether the over current is generated on the DC-DC converter according to the voltage drop across the output inductor (L) when the inductor current (I_{L}) flows through the output inductor (L), and the over current protecting device also may determine whether the over current is generated on the DC-DC converter by detecting the voltage drop across the upper power FET (M1) or the lower power FET (M2) when the inductor current (I_{L}) flows through the upper power FET (M1) or the lower power FET (M2).

FIG. 3 is a schematic diagram showing the signal of the conventional over current protecting device. The over current protecting device operates when the inductor current (I_{L}) reaches a sensing protecting current (Iocp). As shown in FIG. 3, before the time point t1, the DC-DC converter is in the steady state, and the inductor current (I_{L}) equals to the output current (I_{O}) and keeps at a value approximate to the steady state current (I1), and the output voltage (Vout) keeps at the fixed voltage (V1).

After the time point t1, the load on the motherboard is short circuited. At the time point t1, the output current (I_{O}) increases rapidly, and the output voltage (Vout) decreases slightly. However, since the inductor current (I_{L}) cannot increase rapidly, the output capacitor (C) provides the capacitor current (Ic). That is, when the load of the motherboard is short circuited, the output current (I_{O}) is provided by the inductor current (I_{L}) and the capacitor current (Ic). The oblique lines area in FIG. 3 shows the magnitude of the capacitor current (Ic).

At the time point t2, the inductor current (I_{L}) slowly increases to the sensing protecting current (Iocp), and the over current protecting device operates to disable the PWM unit, thereby making the PWM unit stop generating the first driving signal (S1) and the second driving signal (S2). Therefore, the output voltage (Vout), the output current (I_{O}) and the inductor current (I_{L}) decrease to zero rapidly. The over current protecting device needs the period from t1 to t2 to operate and disable the PWM unit.

As shown in the above, the conventional over current protecting device protects the DC-DC converter by detecting the inductor current (I_{L}). However, as shown in FIG. 3, even when the inductor current (I_{L}) does not reach the sensing protecting current (Iocp), the output current (I_{O}) reaches the sensing protecting current (Iocp), and the PWM unit is still enabled. Therefore, electronic devices on the motherboard may be affected by the output current (I_{O}) and damaged. In addition, when the inductor current (I_{L}) reaches the sensing protecting current (Iocp), the upper power FET (M1) and the lower power FET (M2) have to withstand the same current, and the upper power FET (M1) and the lower power FET (M2) are also easily damaged.

### SUMMARY OF THE INVENTION

The invention discloses an over current protecting device adapted to a DC-DC converter and the method thereof. The over current protecting device may detect the output current (Io) directly, and it may determine whether an over current is generated in the DC-DC converter by detecting the voltage drop of the power copper layer on a motherboard, thereby protecting the electronic devices of the whole circuit.

The invention discloses an over current protecting device adapted to a DC-DC converter. A Vout end of the DC-DC converter may generate an output current and transmit the output current to a load on a motherboard via a power copper layer on the motherboard. The over current protecting device includes a voltage drop circuit, a comparator and a sample-and-hold circuit. The comparator has a first input end and a second input end, the voltage drop circuit is connected between the first input end and the Vout end of the DC-DC converter, and the second input end is connected to the load. The sample-and-hold circuit is connected to an output end of the comparator, and it may control the DC-DC converter to operate normally or stop operating according to the signal generated on the output end of the comparator.

The invention discloses an over current protecting device adapted to a DC-DC converter. A Vout end of the DC-DC converter may generate an output current and transmit the output current to a load of a motherboard via a power copper layer of the motherboard. The over current protecting device includes an error amplifier, a sample-and-hold circuit and a comparator. The error amplifier has a first input end and a second input end. The first input end is connected to the Vout end of the DC-DC converter, and the second input end is connected to the load. The sample-and-hold circuit is connected to an output end of the error amplifier and may generate a sampled signal. The comparator compares the sampled signal with a threshold voltage and controls the DC-DC converter to operate normally or stop operating according to the comparing result of the comparator.

The invention discloses an over current protecting method adapted to a DC-DC converter. A Vout end of the DC-DC converter may generate an output current and transmit the output current to a load of the motherboard via a power copper layer on the motherboard. The over current protecting method includes the following steps: detecting a voltage drop on the power copper layer; controlling the DC-DC converter to operate normally when the voltage drop is smaller than a threshold value; and controlling the DC-DC converter to stop operating when the voltage drop is larger than the threshold value.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional DC-DC converter;

FIG. 2 is a schematic diagram showing the output voltage and the output current of the conventional DC-DC converter;

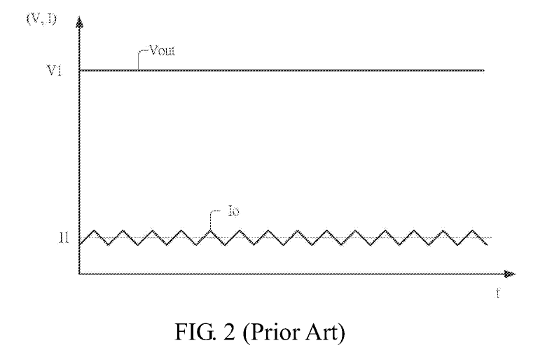

FIG. 3 is a schematic diagram showing the signal of the conventional over current protecting device;

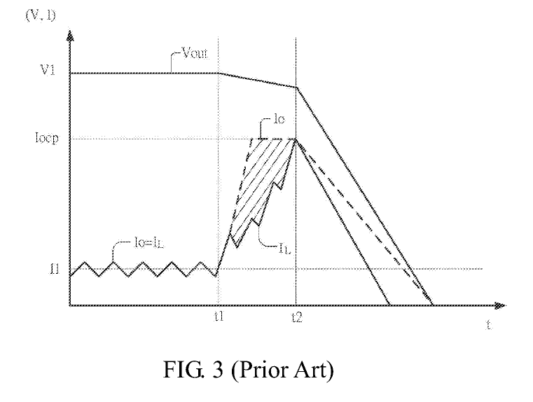

FIG. 4 is a schematic diagram showing an over current protecting device adapted to a DC-DC converter in the first embodiment of the invention;

FIG. 5 is a schematic diagram showing the signal of the over current protecting device in the DC-DC converter in the embodiment of the invention;

FIG. 6 is a schematic diagram showing the over current protecting device adapted to the DC-DC converter in the second embodiment of the invention; and

FIG. 7 is a schematic diagram showing the over current protecting device adapted to the DC-DC converter in the third embodiment of the invention.

### DETAILED DESCRIPTION OF THE PREFERRED EMBODIMENT

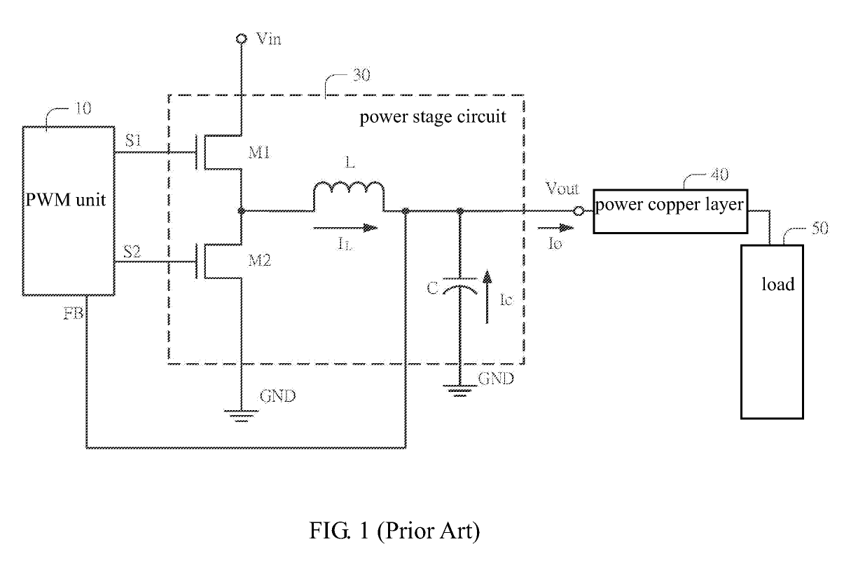

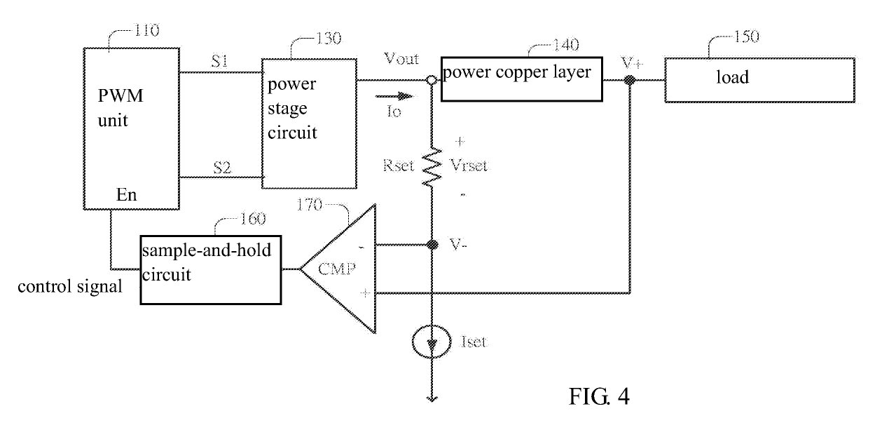

FIG. 4 is a schematic diagram showing an over current protecting device adapted to a DC-DC converter in the first embodiment of the invention. The DC-DC converter includes a PWM unit 110 and a power stage circuit 130. The PWM unit may output a first driving signal (S1) and a second driving signal (S2). The power stage circuit 130 generates an output current (I_{O}) at a Vout end (Vout) according to the first driving signal (S1) and the second driving signal (S2). The output current (I_{O}) is transmitted to the load 50 on a motherboard via a power copper layer 140 on the motherboard. The operating principle of the power stage circuit 130 is the same as that in FIG. 1, and it is not illustrated again for a concise purpose.

The over current protecting device includes a set resistor (Rset), a set current source (Iset), a comparator 170 and a sample-and-hold circuit 160. The set resistor (Rset) is connected between a negative input end of the comparator 170 and the Vout end (Vout) of the power stage circuit 130, and the negative input end of the comparator 170 is connected to the set current source (Iset). A positive input end (V+) of the comparator 170 is connected to the load 150, and an output end of the comparator 170 is connected to the sample-and-hold circuit 160. The sample-and-hold circuit 160 outputs a control signal for enabling or disabling the PWM unit.

According to the first embodiment of the invention, since the impedance of the power copper layer is small, when the DC-DC converter is in the steady state, the output voltage (Vout) is approximately to the voltage (V+) at the positive input end of the comparator 170. In addition, a voltage drop with a set voltage (Vrset) may be generated at the set resistor (Rset) via the set resistor (Rset) and the set current source (Iset). Therefore, the voltage (V−) at the negative input end of the comparator 170 is fixed to be (Vout-Vrset), and the voltage may be considered as the threshold voltage.

When the DC-DC converter is in the steady state, the voltage (V+) at the positive input end of the comparator 170 is larger than the voltage (V−) at the negative input end of the comparator 170. The output end of the comparator 170 generates a high-level to the sample-and-hold circuit 160, and the sample-and-hold circuit 160 generates a corresponding control signal according to the high-level to enable the PWM unit 110, thereby making the DC-DC converter operate normally.

When the load on the motherboard is short circuited, the output current (I_{O}) increases rapidly, and the voltage drop generated when the output current (I_{O}) flows through the power copper layer 140 becomes larger. When the voltage (V+) of the positive input end of the comparator 170 is smaller than the voltage (V−) at the negative input end of the comparator 170 (namely the threshold voltage), the output end of the comparator 170 generates a low-level to the sample-and-hold circuit 160, and the sample-and-hold circuit 160 generates a corresponding control signal according to the received low-level to disable the PWM unit 110, thereby making the DC-DC converter stop operating, and the output current (I_{O}) decrease rapidly.

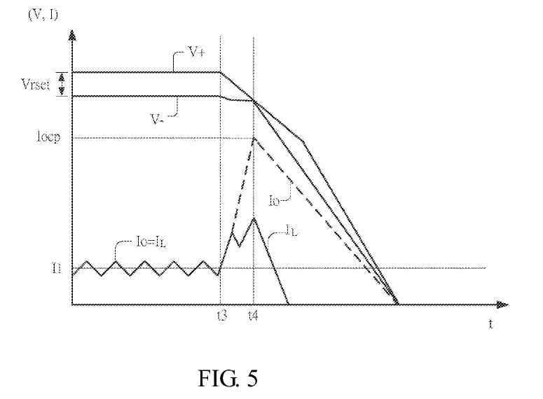

FIG. 5 is a schematic diagram showing the signal of the over current protecting device in the DC-DC converter in the embodiment of the invention. Before the time point t3, the DC-DC converter is in the steady state, the voltage (V+) at the positive input end of the comparator 170 is larger than the voltage (V−) at the negative input end of the comparator 170, and the DC-DC converter operate normally. At the time point t3, the motherboard is short circuited, the output current (I_{O}) increases rapidly, and the voltage drop across the power copper layer 140 when the output current (I_{O}) flows through the power copper layer 140 becomes larger. At the time point t4, the voltage (V+) at the positive input end of the comparator 170 is smaller than the voltage (V−) at the negative input end of the comparator 170, and the output current (I_{O}) reaches the sensing protecting current (Iocp). Therefore, the output end of the comparator 170 generates the low-level to the sample-and-hold circuit 160, and the sample-and-hold circuit 160 generates the corresponding control signal to disable the PWM unit 110 according to the received low-level. After the time point t4, the DC-DC converter stops operating, and the output current (I_{O}) decreases rapidly.

The over current protecting device only needs the period from t3 to t4 to turn off the PWM unit. Comparing with the conventional over current protecting device, the PWM unit is turned off more quickly. In addition, the over current protecting device in the invention protects the DC-DC converter by detecting the output current (I_{O}). Consequently, when the output current (I_{O}) reaches the sensing protecting current (Iocp), the inductor current (I_{L}) does not reach the sensing protecting current (Iocp), and the upper power FET (M1) and the lower power FET (M2) of the power stage circuit 130 would not be damaged.

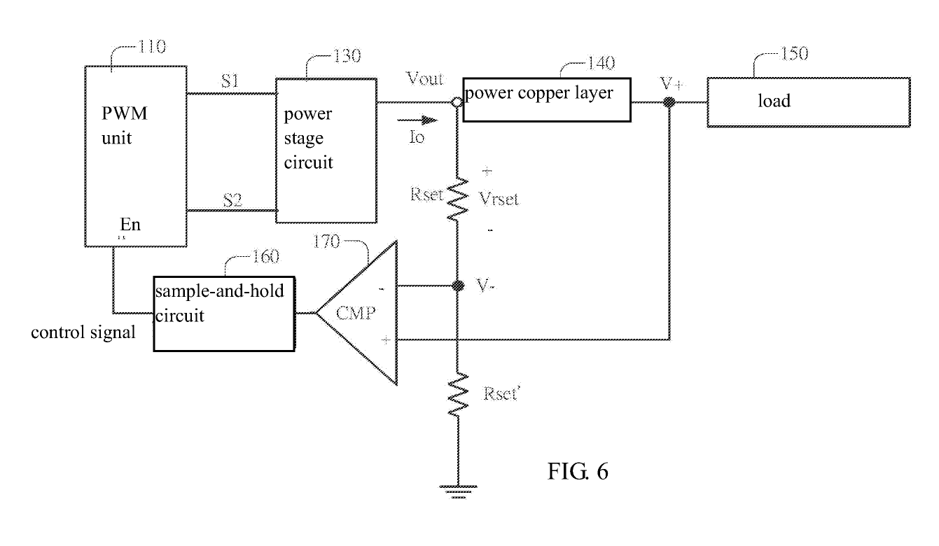

FIG. 6 is a schematic diagram showing the over current protecting device adapted to the DC-DC converter in the second embodiment of the invention. The difference between the first embodiment and the second embodiment is that a first set resistor (Rset) and a second set resistor (Rset') are connected between the Vout end (Vout) and the ground in series in the second embodiment, and the negative input end of the comparator 170 is connected to the connecting node of the first set resistor (Rset) and the second set resistor (Rset'). The set voltage (Vrset) is determined according to the divided voltages across the first set resistor (Rset) and the second set resistor (Rset′), and the operating principle in the second embodiment is the same as that in the first embodiment, and it is not illustrated again for a concise purpose.

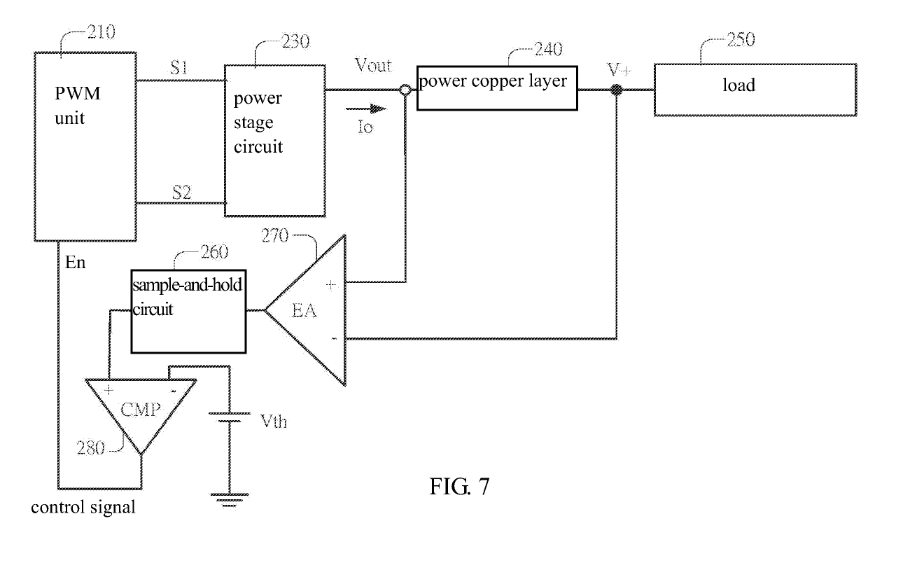

FIG. 7 is a schematic diagram showing the over current protecting device adapted to the DC-DC converter in the third embodiment of the invention. The DC-DC converter includes a PWM unit 210 and a power stage circuit 230. The PWM unit 210 outputs the first driving signal (S1) and the second driving signal (S2). In addition, the power stage circuit 230 generates an output current (I_{O}) at the Vout end (Vout) according to the first driving signal (S1) and the second driving signal (S2). The output current (I_{O}) is transmitted to a load 250 of a motherboard via a power copper layer 240 on the motherboard.

In addition, the over current protecting device includes an error amplifier 270, a sample-and-hold circuit 260, a comparator 280 and a threshold voltage (Vth). A positive input end (V+) of the error amplifier 270 is connected to a Vout end (Vout) of the power stage circuit 230, and a negative input end of the error amplifier 270 is connected to the load 250. The output end of the error amplifier 270 is connected to the sample-and-hold circuit 260, and the sample-and-hold circuit 260 may output a sampled signal to a positive input end (V+) of the comparator 280. The negative input end of the comparator 280 receives the threshold voltage (Vth), and the output end of the comparator 280 outputs the control signal to enable or disable the OCP function of the PWM unit.

Since the impedance of the power copper layer is small, when the DC-DC converter is in the steady state, the voltage drop on the power copper layer 240 is small. The error amplifier 270 amplifies the voltage drop, and the sample-and-hold circuit 260 samples the amplified voltage drop to generate the sampled signal and transmit the sampled signal to the positive input end of the comparator.

According to an embodiment of the invention, when the DC-DC converter is in the steady state, the sampled signal outputted by the sample-and-hold circuit 260 is smaller than the threshold voltage (Vth) to make the output end of the comparator 280 generate the low-level control signal to enable the PWM unit 210, thereby making the DC-DC converter operate normally.

On the contrary, when the load of the motherboard is short circuited, the voltage drop of the power copper layer 240 is large, and the error amplifier 270 amplifies the voltage drop. Afterwards, the sample-and-hold circuit 260 samples the amplified voltage drop to generate the sampled signal and transmit the sampled signal to the positive input end of the comparator 280.

According to the embodiment of the invention, when the load of the motherboard is short circuited, the sampled signal outputted by the sample-and-hold circuit 260 is larger than the threshold voltage (Vth), and the output end of the comparator 280 generates a high-level control signal to disable the PWM unit 210, thereby making the DC-DC converter stop operating and making the output current (I_{O}) decrease rapidly.

According to the embodiments above, the invention discloses an over current protecting device adapted to DC-DC converter and method thereof. The over current protecting device may detect the output current (I_{O}) directly and determine whether the over current is generated on the DC-DC converter by detecting the voltage drop on the power copper layer of the motherboard. When the voltage drop on the power copper layer is not larger, the PWM unit is enabled, and when the voltage drop is too large, the PWM unit is disabled.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. An over current protecting device adapted to a direct current to direct current (DC-DC) converter, wherein a Vout end of the DC-DC converter is capable of generating an output current and transmitting the output current to a load on a motherboard via a power copper layer on the motherboard, the over current protecting device comprising:
a voltage drop circuit;
a comparator having a first input end and a second input end, wherein the voltage drop circuit is connected between the first input end and the Vout end of the DC-DC converter, and the second input end is connected to the load; and
a sample-and-hold circuit connected to an output end of the comparator, wherein the sample-and-hold circuit controls the DC-DC converter to operate normally or stop operating according to the signal generated from the output end of the comparator.

2. The over current protecting device according to claim 1, wherein the voltage drop circuit comprises:
a set resistor connected between the first input end of the comparator and the Vout end of the DC-DC converter; and
a set current source connected to the first input end of the comparator.

3. The over current protecting device according to claim 1, wherein the voltage drop circuit comprises:
a first set resistor connected between the first input end of the comparator and the Vout end of the DC-DC converter; and
a second set resistor connected between the first input end of the comparator and the ground.

4. The over current protecting device according to claim 1, wherein the first input end of the comparator is a negative input end and the second input end of the comparator is a positive input end.

5. The over current protecting device according to claim 1, wherein the DC-DC converter comprises:
a pulse width modulation (PWM) unit outputting a first driving signal and a second driving signal; and
a power stage circuit generating an output current at the Vout end according to the first driving signal and the second driving signal.

6. The over current protecting device according to claim 5, wherein the DC-DC converter operates normally when the PWM unit is enabled, and the DC-DC converter stops operating when the PWM unit is disabled.

7. The over current protecting device according to claim 1, wherein the output end of the comparator generates a first level to make the sample-and-hold circuit control the DC-DC converter to stop operating when the motherboard is short circuited; and the output end of the comparator generates a second level to make the sample-and-hold circuit control the DC-DC converter to operate normally when the motherboard is not short circuited.

8. An over current protecting device adapted to a DC-DC converter, wherein a Vout end of the DC-DC converter is capable of generating an output current and transmitting the output current to a load on a motherboard via a power copper layer on the motherboard, the over current protecting device comprising:
an error amplifier having a first input end and a second input end, wherein the first input end is connected to the Vout end of the DC-DC converter, and the second input end is connected to the load;
a sample-and-hold circuit connected to an output end of the error amplifier and generating a sampled signal; and
a comparator comparing the sampled signal with a threshold voltage and controlling the DC-DC converter to operate normally or stop operating according to the comparing result of the comparator.

9. The over current protecting device according to claim 8, wherein the first input end of the error amplifier is a positive input end and the second input end of the error amplifier is a negative input end.

10. The over current protecting device according to claim 8, wherein the DC-DC converter comprises:
a PWM unit outputting a first driving signal and a second driving signal; and
a power stage circuit generating an output current at the Vout end according to the first driving signal and the second driving signal.

11. The over current protecting device according to claim 10, wherein the DC-DC converter operates normally when the PWM unit is enabled, and the DC-DC converter stops operating when the PWM unit is disabled.

12. The over current protecting device according to claim 8, wherein the output end of the comparator generates a first level to make the DC-DC converter stop operating when the motherboard is short circuited; and the output end of the comparator generates a second level to make the DC-DC converter operate normally when the motherboard is not short circuited.

13. An over current protecting method adapted to a DC-DC converter, wherein a Vout end of the DC-DC converter is capable of generating an output current and transmitting the output current to a load of a motherboard via a power copper layer on the motherboard, the over current protecting method comprising the steps of:
detecting a voltage drop on the power copper layer;
controlling the DC-DC converter to operate normally when the voltage drop is smaller than a threshold value; and
controlling the DC-DC converter to stop operating when the voltage drop is larger than the threshold value.

14. The over current protecting method according to claim 13, wherein the DC-DC converter comprises:
a PWM unit outputting a first driving signal and a second driving signal; and
a power stage circuit generating an output current at the Vout end according to the first driving signal and the second driving signal.

15. The over current protecting method according to claim 14, wherein the DC-DC converter operates normally when the PWM unit is enabled, and the DC-DC converter stops operating when the PWM unit is disabled.
